(19) United States
(12) Patent Application Publication
(10) Pub. No.: US 2006/0062613 A1
(43) Pub. Date: Mar. 23, 2006

(54) Image forming apparatus and developer

(76) Inventor: Masamichi Aoki, Tokyo (JP)

Correspondence Address: RABIN & Berdo, PC, 1101 14TH STREET, NW, SUITE 500, WASHINGTON, DC, 20005, US

(21) Appl. No.: 10/944,048

(22) Filed: Sep. 20, 2004

(51) Int. Cl. G03G 21/00

(52) U.S. Cl. 399/350; 430/125; 430/110.4; 430/108.1

(57) ABSTRACT

An image forming apparatus includes an image bearing body, a charging unit that electrically charges the image bearing body, a latent image forming unit that forms latent image on the image bearing body charged by the charging unit, a developing unit that develops the latent image on the image bearing body by means of a developer including mother particles and external additives, a transfer unit that transfers a developed image to a medium, and a cleaning unit having a cleaning blade that removes the developer remaining on the image bearing body. A rebound elasticity of the cleaning blade is from 40% to 80%. A degree of circularity of the mother particle of the developer is greater than or equal to 0.94. When 1 weight part of the developer is dispersed in 3.5 weight parts of ethyl-alcohol and 100 weight parts of water to obtain a dispersion, a turbidity of the dispersion ranges from 20 to 40.

### BACKGROUND OF THE INVENTION

This invention relates to an image forming apparatus such as a printer, a copier, a facsimile that forms an image by means of electrophotography, and relates to a developer used in the image forming apparatus.

Conventionally, in an image forming apparatus such as a printer, a copier, a facsimile, a latent image is formed on an image bearing body (for example, a photosensitive body or a dielectric body). The latent image is developed with a toner (i.e., a developer), and the developed toner image is transferred to a recording paper. In this state, most of the toner on the image bearing body is transferred to the recording paper, but a part of the toner may remain on the image bearing body. The toner (i.e., the residual toner) that remains on the image bearing body may cause an image defect, and therefore such a residual toner is removed from the image bearing body by means of a cleaning blade.

In order to effectively remove the residual toner from the image bearing body, Japanese Laid-open patent publication No. 2002-207314 (in particular, pages 4-7 and FIG. 2) discloses the use of the toner including mother particles and external additives of aluminum oxide. According to the above described publication, the cleaning performance can be enhanced by adjusting the content of free mother particles (to which the external additives do not adhere) and the content of free external additives which do not adhere to the mother particles.

However, recently, in order to meet the demand for high quality image, it is required to use a toner whose particle shape is substantially spherical. Such toner tends to easily pass through between the cleaning blade and the image bearing body. Therefore, the toner can not sufficiently be removed by the cleaning blade, even when the contents of the free mother particles and free external additives are adjusted. As a result, the toner that remains on the image bearing body may adhere to a charging roller or the like, with the result that the image defect may occur.

### SUMMARY OF THE INVENTION

An object of the present invention is to provide an image forming apparatus and a developer thereof capable of improving the cleaning performance even when the particle shape of the developer is substantially spherical.

The present invention provides an image forming apparatus comprising an image bearing body, a charging unit that electrically charges the image bearing body, a latent image forming unit that forms a latent image on the image bearing body charged by the charging unit, a developing unit that develops the latent image on the image bearing body by means of a developer including mother particles and external additives, a transfer unit that transfers a developed image to a medium, and a cleaning unit having a cleaning blade that removes the developer that remains on the image bearing body without being transferred to the medium. A rebound elasticity of the cleaning blade ranges from 40% to 80%. A mean value of degrees of circularity of the mother particles is greater than or equal to 0.94. When 1 weight part of the developer is dispersed in 3.5 weight parts of ethyl-alcohol and 100 weight parts of water to obtain a dispersion, a turbidity of the dispersion ranges from 20 to 40.

The present invention also provides an image forming apparatus comprising an image bearing body, a charging unit that electrically charges the image bearing body, a latent image forming unit that forms a latent image on the image bearing body charged by the charging unit, a developing unit that develops the latent image on the image bearing body by means of a developer including mother particles and external additives, a transfer unit that transfers a developed image to a medium, and a cleaning unit having a cleaning blade that removes the developer that remains on the image bearing body without being transferred to the medium. A rebound elasticity of the cleaning blade ranges from 40% to 80%. A mean value of degrees of circularity of the mother particles is greater than or equal to 0.94. The external additives include at least one kind of external additives whose mean particle diameter is greater than or equal to 100 nm. When 1 weight part of the developer is dispersed in 3.5 weight parts of ethyl-alcohol and 100 weight parts of water to obtain a dispersion, a turbidity of the dispersion ranges from 10 to 40.

With such an arrangement, it is possible to prevent the toner from passing through between the cleaning blade and the image bearing body, even when the particle shape of the developer is substantially spherical. Therefore, the cleaning performance can be improved, with the result that the image quality can be improved.

### BRIEF DESCRIPTION OF THE DRAWINGS

In the attached drawings:

FIG. 1 is a side view illustrating the main part of an image forming apparatus according to the first embodiment of the present invention;

FIG. 2 is a schematic view illustrating the general structure of the image forming apparatus according to the first embodiment of the present invention; and

FIG. 3 is a schematic view illustrating a function of a cleaning blade of the image forming apparatus according to the first embodiment of the present invention.

### DETAILED DESCRIPTION OF THE PREFERRED EMBODIMENT

Embodiments of the present invention will be described with reference to the attached drawings.

### FIRST EMBODIMENT

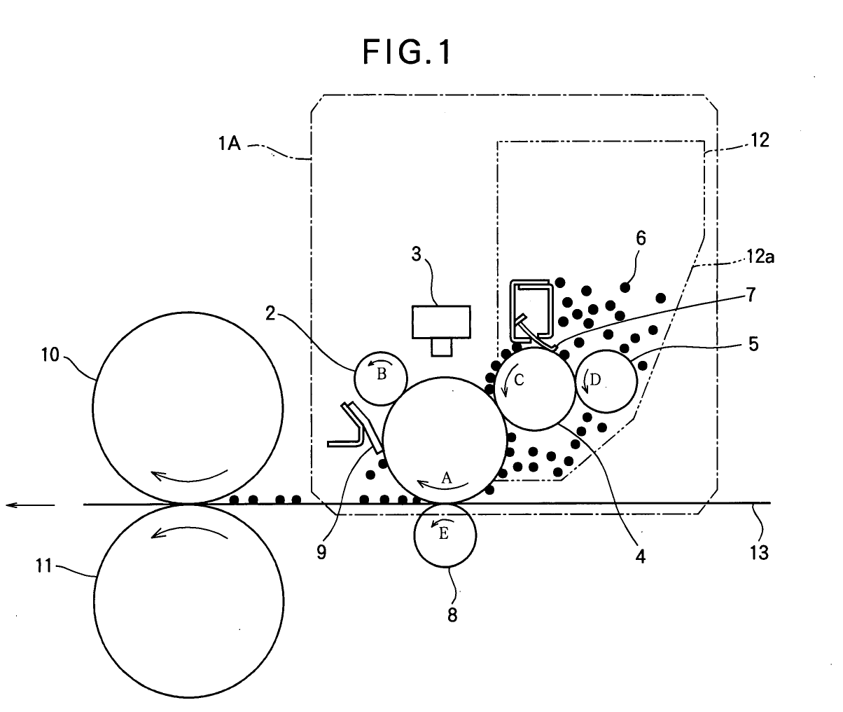

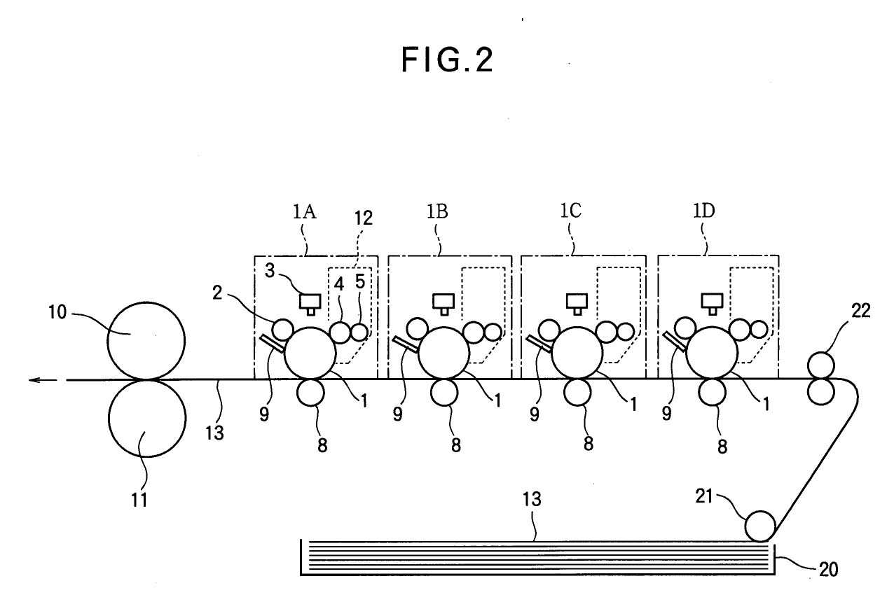

FIG. 1 is a side view illustrating the main part of an image forming apparatus according to the first embodiment of the present invention. FIG. 2 is a schematic view illustrating the general structure of the image forming apparatus shown in FIG. 1. As shown in FIG. 1, the image forming apparatus includes a photosensitive drum (i.e., an image bearing body) 1 that rotates clockwise as shown by an arrow A in FIG. 1 at a constant speed. Along the rotational direction of the photosensitive drum 1, a charging roller (i.e., a charging unit) 2, an exposing unit (i.e., a latent image forming unit) 3, a developing unit 12, a transfer roller (i.e., a transfer unit) 8 and a cleaning blade (i.e., a cleaning unit) 9 are arranged in this order.

The photosensitive drum 1 includes a drum-shaped conductive support and a photoconductive layer formed on the surface of the conductive support. The charging roller 2 includes a metal shaft on which a semiconductive rubber layer is formed. A direct voltage is applied to the charging roller 2 by a first high voltage power source (not shown). The charging roller 2 rotates counter-clockwise as shown by an arrow B in FIG. 1 at a constant speed in such a manner that the charging roller 2 is urged against or contacts the surface of the photosensitive drum 1. The exposing unit 2 includes, for example, LEDs (Light Emitting Diodes) that emit the light to the surface of the photosensitive drum 1 according to the image information, so that a latent image is formed on the surface of the photosensitive drum 1.

The developing unit 12 includes a container 12a accommodating a toner (i.e., a developer) 6, and further includes a developing roller 4 and the toner supply roller 5 in the container 12a. The developing roller 4 rotates counterclockwise as shown by an arrow C in FIG. 1 at a constant speed. A bias voltage is applied to the developing roller 4 by a second high voltage power source (not shown) so that the toner 6 on the developing roller 4 adheres to the surface of the photosensitive drum 1 by electrostatic force. A blade 7 contacts the surface of the developing roller 4, for determining the thickness of the toner layer formed on the developing roller 4. The toner supply roller 5 is provided in opposition to the developing roller 4, and rotates counterclockwise as shown by an arrow D in FIG. 1. A bias voltage is applied to the toner supply roller 5 by a third high voltage power supply (not shown) so that the toner 6 on the toner supply roller 5 adheres to the developing roller 4.

The transfer roller 8 is provided in opposition to the photosensitive drum 1 via a feeding path of the recording paper 13, and rotates counterclockwise as shown by an arrow E in FIG. 1. A bias voltage is applied to the transfer roller 8 by a fourth high voltage power supply (not shown) so that the toner transfers from the surface of the photosensitive drum 1 to the recording paper 13.

The cleaning blade 9 is a member having rubber elasticity and is provided in opposition to the photosensitive drum 1. In particular, the cleaning blade 9 is made of urethane elastomer. The main components of urethane elastomer are isocyanate and polyol, and the rebound elasticity of the cleaning blade 9 can be adjusted by varying the ratio of isocyanate to polyol. Further, the rebound elasticity of the cleaning blade 9 can also be adjusted by adding trifunctional isocyanate to normal isocyanate (usually bifunctional), and by adjusting the ratio of the trifunctional isocyanate to the bifunctional isocyanate. For example, the rebound elasticity of the cleaning blade 9 can be lowered by decreasing the content of the bifunctional isocyanate and by increasing the content of the trifunctional isocyanate. The cleaning blade 9 can be made of a material having rubber elasticity other than urethane elastomer.

The photosensitive drum 1, the charging roller 2, the exposing unit 3, the developing unit 12, the transfer roller 8 and the cleaning blade 9 constitute an image forming unit 1A. As shown in FIG. 2, the image forming apparatus includes image forming units 1B, 1C and 1D, in addition to the image forming unit 1A. Each of the image forming units 1B, 1C and 1D is different from the image forming unit 1A only in the color of the toner. The image forming unit 1A, 1B, 1C and 1D are arranged on a feeding path of the recording paper 13, and respectively form images of yellow, magenta, cyan and black on the recording paper 13.

The image forming apparatus has a cassette 20 in which the recording papers 13 are stacked, and a pickup roller 21 that picks up each recording paper 13 from the cassette 20. A pair of feeding rollers 22 are disposed in adjacent to the image forming units 1A through 1D, for feeding the recording paper 13 from the pickup roller 21 to the image forming units 1A through 1D. On the downstream side (i.e., the left side) of the image forming units 1A through 1D, a fixing unit is provided. The fixing unit includes a heat roller 10 and a pressure roller 11 that nip the recording paper 13 to which the toner image has been transferred, and apply heat and pressure to the recording paper 13 so that the image is fixed to the recording paper 13.

The basic operation of the image forming apparatus will be described. First, the photosensitive drum 1 starts to rotate at a constant speed. Further, the charging roller 2 to which the high voltage is applied rotates in contact with the surface of the photosensitive drum 1 so as to uniformly charge the surface of the photosensitive drum 1. Then, the exposing unit 3 exposes the surface of the photosensitive drum 1 with light according to the image information, so as to form latent image on the surface of the photosensitive drum 1. In the developing unit 12, the toner supply roller 5 rotates so that the toner 6 accommodated in the container 12a adheres to the surface of the developing roller 4. The developing roller 4 also rotates so that the toner 6 on the developing roller 4 adheres to the latent image on the photosensitive drum 1 by the electrostatic force, with the result that the toner image is formed on the photosensitive drum 1.

The recording paper 13 is picked up from the cassette 20 by the pickup roller 21. The feeding rollers 22 correct the skew of the recording paper 13, and feed the recording paper 13 to the image forming units 1A through 1D. As the recording paper 13 passes through between the photosensitive drum 1 and the transfer roller 8 of each image forming unit, the toner image on the photosensitive drum 1 is transferred to the recording paper 13 because of the bias voltage between the photosensitive drum 1 and the transfer roller 8. As the recording paper 13 passes the image forming units 1A through 1D, the toner images of yellow, magenta, cyan and black are transferred to the recording paper 13.

The recording paper 13 on which the toner image is transferred is fed through a nip portion between the heat roller 10 and the pressure roller 11. The recording paper 13 is heated and pressed by the heat roller 10 and the pressure roller 11, so that the toner image is fixed to the recording paper 13. After the image is fixed to the recording paper 13, the recording paper 13 is ejected outside of the image forming apparatus. Although a part of the toner may remain on the photosensitive drum 1, such a residual toner is removed by the cleaning blade 9, so that the photosensitive drum 1 can bear new latent image.

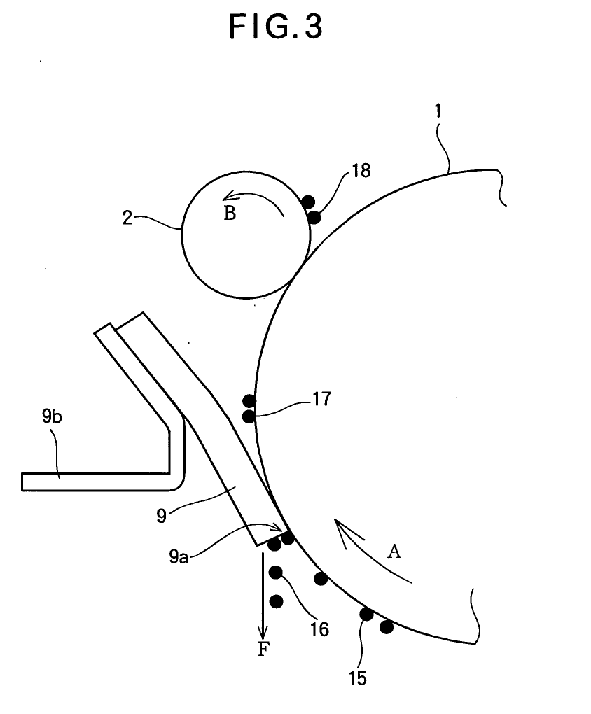

FIG. 3 is a schematic view illustrating how the cleaning blade 9 removes the residual toner. The toner includes mother particles and external additives as described below, and the mean particle diameter of the mother particles ranges from 6 to 8 μm. The cleaning blade 9a is elongated in the axial direction of the photosensitive drum 1. The cleaning blade 9 is supported by a supporting member 9b in such a manner that an end 9a (in the width direction of the cleaning blade 9) contacts the surface of the photosensitive drum 1. By the rotation of the photosensitive drum 1 shown by the arrow A in FIG. 3, the residual toner 15 that remains on the photosensitive drum 1 abuts against the edge 9a of the cleaning blade 9, and is scraped from the surface of the photosensitive drum 1 as shown by an arrow F in FIG. 3. The toner scraped from the photosensitive drum 1 is collected by a not shown toner recovery portion. Conversely, if the toner passes through between the photosensitive body 1 and the cleaning blade 9 (i.e., if the cleaning failure occurs), the toner denoted by numeral 17 may adhere to the charging roller 2. The toner 18 that adheres to the charging roller 2 interferes with the uniform charging of the surface of the photosensitive drum 1, and a non-charged part is formed on the photosensitive drum 1. Such a non-charged part on the photosensitive drum 1 does not attract the toner, and therefore a low density part (an image defect) is formed on the toner image on the recording paper 13.

The condition for preventing the occurrence of the cleaning failure will be described.

[Manufacturing of Toner]

The toner, including mother particles and external additives, is manufactured as described below. First, the mother particles are made by emulsion aggregation. In emulsion aggregation, a water solution is prepared, which includes 6 weight parts of sodium dodecylbenzene-sulfonate and 2 weight parts of nonyl phenol polyethylene oxide 10-mol added product, and 900 weight parts of ion-exchange water.

Then, a monomer-solution is prepared, which includes 65 weight parts of styrene, 35 weight parts of n-butyl methacrylate, 6 weight parts of methacrylate, 3 weight parts of t-dodecylmercaptan. The monomer-solution is added to the above described water solution, and the resulting solution is stirred. While the solution is stirred under the nitrogen, the solution is heated to 75 degrees centigrade.

To the resulting solution, a water solution including 3 weight parts of potassium peroxide and 140 weight parts of ion exchange water is added. The solution reacts at 75 degrees centigrade for 6 hours, with the result that a polymer-primary-particle emulsion (i.e., a resin emulsion) is obtained. Next, a wax emulsion with solid content of 20 wt % is obtained by heating and emulsifying paraffin wax in water using surface active agent. At room temperature, 50 weight parts of the wax emulsion is added to the above described resin emulsion. Then, 6.7 weight parts (i.e., solid content only) of water solution of phthalocyanine blue is added to the resin emulsion.

To 400 weight parts of the resultant emulsion, 103 weight parts of ion exchange water in which 40 weight parts of sodium chloride is solved is added. Furthermore, 30 weight parts of ion exchange water 30 in which 67 weight parts of isopropanol and 3.6 weight parts of polyoxyethylene-octyl-phenyl-ether (mean degree of polymerization is 10) are solved is added to the emulsion. Then, the emulsion is heated to 85 degree centigrade, so that a salting-out/fusion proceeds. By adjusting the time for the salting-out/fusion, two kinds of mother particles A and B having different degrees of circularities are obtained. The degree of circularity of the mother particles (mean value of plural particles) A is 0.99. The degree of circularity of the mother particles B is 0.94.

The degree of circularity is measured by “Flow Particle Image Analyzer FPIA 2100” manufactured by Sysmex Corporation according to the following equation (1).
Degree of Circularity=L1/L2 (1)
where L1 represents the circumferential length of an equivalent circle whose area is the same as the area of the projected image of the particle, and L2 represents the circumferential length of the projected image of the particle. If the degree of circularity is 1, the form of the particle is true sphere. As the degree of circularity becomes smaller than 1, the form of the particle becomes indefinite.

Then, external additives are added to 100 weight parts of the respective mother particles. The external additives are silica “R202” (manufactured by Nippon Aerosil Co. Ltd), silica “RX50” (manufactured by Nippon Aerosil Co. Ltd), and titania “T805” (manufactured by Nippon Aerosil Co. Ltd). The amounts of the respective external additives are described later. The external additives and the mother particles are stirred by Henschel mixer (manufactured by Mitsui Mining Co. Ltd) at a rotation speed of 2100 rpm.

Silica “R202” mainly has a role as an fluidizing agent. Silica “RX50” mainly has a role of preventing the fluidity from decreasing with time. Titania “T805” mainly has a role of stabilizing the electric charge. The mean particle diameters of silica “R202”, silica “RX50” and titania “T805” are respectively 14 nm, 40 nm and 21 nm.

The amount of titania “T805” (0.2 weight parts) is constant, but the amount of silica “R202” (0.5 or 0.7 weight parts), the amount of silica “RX50” (1.0 or 2.0 weight parts), and the stirring time (1 to 6 minutes) are varied so that 10 kinds of toner (referred to as toner 1 through 10) are obtained. The amount of the respective external additives and the stirring time are shown in Table 1.

[Measurement]

The measurement of the turbidity (i.e., haze) is performed. 1 weight part of the respective toner (i.e., the toner 1 through 10) is added to 3.5 weight parts of ethyl-alcohol, and ultrasonically dispersed for 5 minutes. Then, 100 weight parts of the ion exchange water is added to the above described toner and ethyl-alcohol, and is again ultrasonically dispersed for 5 minutes. After the toner is sufficiently dispersed, the dispersion is left for 48 hours. Then, after the precipitant and the floating substance are removed from the dispersion, the turbidity of the dispersion is measured by means of “Haze Meter NDH2000” manufactured by Nippon Denshoku Industries Co. Ltd.

After the precipitant and the floating substance are removed form the dispersion, the mother particles (and the external additives adhering to the mother particles) do not exist in the dispersion. The external additives in the dispersion include (1) the external additives which have not adhere to the mother particles when toner is manufactured, and (2) the external additives which have initially adhere to the mother particles but separates therefrom because of the weak adhering force in the above described dispersion process. The turbidity of the dispersion increases as the amount of the external additives apart from the mother particles (in a state where the stress is applied to the toner in the image forming apparatus) increases.

The result of the measurement of the turbidity is shown in Table 1. In Table 1, the amounts of the external additives are with respect to 100 weight parts of the mother particles.

TABLE 1

| | mother | amount (weight parts) | | | stir | |
|---|---|---|---|---|---|---|
| | particle | silica | silica | titania | time | |
| toner | (A/B) | R202 | RX50 | T805 | (min) | turbidity |
| 1 | A | 0.5 | 1.0 | 0.2 | 6 | 4.8 |
| 2 | B | 0.5 | 1.0 | 0.2 | 5 | 8.6 |
| 3 | A | 0.5 | 1.0 | 0.2 | 4 | 20.7 |
| 4 | B | 0.5 | 2.0 | 0.2 | 4 | 25.8 |
| 5 | A | 0.5 | 2.0 | 0.2 | 3 | 29.8 |
| 6 | B | 0.7 | 2.0 | 0.2 | 3 | 34.5 |
| 7 | A | 0.7 | 2.0 | 0.2 | 2 | 37.4 |
| 8 | B | 0.7 | 2.0 | 0.2 | 2 | 39.5 |
| 9 | A | 0.7 | 2.0 | 0.2 | 1 | 43.6 |
| 10 | B | 0.7 | 2.0 | 0.2 | 1 | 44.1 |

Then, using the toner 1 through 10, the cleaning performance in the image forming apparatus is evaluated. In the image forming apparatus, the cleaning blade 9 with a rebound elasticity varied from 30% to 85% contacts the surface of the photosensitive drum 1. The “rebound elasticity” is defined by JIS-K6255. The feeding speed of the recording paper is set to 120 mm/sec. The patterns of the duty ratio 100% (i.e., a solid print) is continuously printed on 30000 recording papers. After the printing, the presence of the image defect (due to the cleaning failure) on the printed image is checked. The result of the evaluation is shown in Table. 2.

TABLE 2

| | Cleaning Performance | | | | |
|---|---|---|---|---|---|
| toner | RE 30% | RE 40% | RE 60% | RE 80% | RE 85% |
| 1 | X | X | X | X | X |
| 2 | X | X | X | X | X |
| 3 | X | ◯ | ◯ | ◯ | X |
| 4 | X | ◯ | ◯ | ◯ | X |
| 5 | X | ◯ | ◯ | ◯ | X |
| 6 | X | ◯ | ◯ | ◯ | X |
| 7 | X | ◯ | ◯ | ◯ | X |
| 8 | X | ◯ | ◯ | ◯ | X |
| 9 | X | X | X | X | X |
| 10 | X | X | X | X | X |

In Table 2, “0” indicates that the image defect due to the cleaning failure is not found. “x” indicates that the image defect due to the cleaning failure is found. RE represents the rebound elasticity of the cleaning blade 9.

According to Tables. 1 and 2, the cleaning failure does not occur when the turbidity of the dispersion ranges from 20 to 40 (i.e., toner 3 through 8) and the rebound elasticity of the cleaning blade 9 ranges from 40% to 80%. It is considered that the external additives are accumulated at a portion between the edge 9a of the cleaning blade 9 and the photosensitive body 1, and prevent the following toner from crawling into between the edge 9a of the cleaning blade 9 and the photosensitive body 1.

The reasoning of this experimental result will be further considered. If the turbidity of the dispersion is less than 20, the amount of the external additives accumulated at the portion between the edge 9a of the cleaning blade 9 and the photosensitive drum 1 is small, and therefore the external additives can not sufficiently prevent the toner from passing through between the edge 9a of the cleaning blade 9 and the photosensitive drum 1, with the result that the cleaning failure may occur. Further, if the turbidity of the dispersion is greater than 40, the amount of the free external additives (which do not adhere to the mother particles) is too large, and therefore the free external additives may stick to the scratch of the photosensitive drum 1 and may cause filming. Because of the filming, the cleaning blade 9 may be damaged, and therefore the toner easily passes through between the edge 9a of the cleaning blade 9 and the photosensitive drum 1, with the result that the cleaning failure may occur.

Conversely, if the turbidity ranges from 20 to 40, the external additives are accumulated at the portion between the edge 9a of the cleaning blade 9 and the photosensitive drum 1 so as to prevent the toner from passing through between the edge 9a of the cleaning blade 9 and the photosensitive drum 1. Further, the amount of the free external additives is not too large, and therefore the filming do not occur, with the result that the cleaning blade 9 is not damaged. As a result, the occurrence of the cleaning failure can be prevented.

Moreover, if the rebound elasticity of the cleaning blade 9 is less than 40%, the edge 9a of the cleaning blade 9 may be deformed by the toner crawling into between the edge 9a and the photosensitive drum 1. As a result, the toner can pass through between the edge 9a of the cleaning blade 9 and the photosensitive drum 1, and therefore the cleaning failure may occur. Further, if the rebound elasticity of the cleaning blade 9 is greater than 80%, abrasion or chipping of the cleaning blade 9 may occur due to the lack of endurance of the cleaning blade 9. As a result, the toner easily passes through the portion of the cleaning blade 9 in which the chipping or the like occurs, and therefore the cleaning failure may occur.

Conversely, if the rebound elasticity of the cleaning blade 9 is from 40% to 80%, the edge 9a of the cleaning blade 9 is not easily deformed by the toner, and abrasion and chipping do not easily occur. As a result, the occurrence of the cleaning failure can be prevented.

As described above, according to the first embodiment of the present invention, in the case where the turbidity of the dispersion (in which 1 weight part of the toner is dispersed in 3.5 weight parts of ethyl alcohol and 100 weight parts of water) ranges from 20 to 40, and the rebound elasticity of the cleaning blade 9 ranges from 40% to 80%, it is possible to improve the cleaning performance and to thereby improve the image quality even when the particle shape of the toner is substantially spherical (i.e., the degree of circularity of the mother particle is greater than 94) is used.

### SECOND EMBODIMENT

In the second embodiment of the present invention, at least one kind of external additive whose mean particle diameter is greater than 100 nm is used. Other elements in the second embodiment are the same as those in the first embodiment.

As an example of the external additive whose mean particle diameter is greater than 100 nm, “SEAHOSTAR KE-P10-S1” (manufactured by Nippon Shokubai Co. Ltd) whose mean particle diameter is 110 nm is used in the experiment. The experiment is performed as was described in the first embodiment. After the mother particles A and B are manufactured as described in the first embodiment, “SEAHOSTAR KE-P10-S1” (manufactured by Nippon Shokubai Co. Ltd), silica “R202”, silica “RX50” and titania “T805” (manufactured by Nippon Aerosil Co. Ltd) are added to the respective mother particles, and stirred by Henschel mixer (manufactured by Mitsui Mining Co. Ltd) at a rotation speed of 2350 rpm. The mean particle diameters of silica “R202”, silica “RX50” and titania “T805” are described in the first embodiment.

The amount of titania “T805” (0.2 weight parts) is constant, but the amount of “SEAHOSTAR KE-P10-S1” (0.5, 1.0 or 1.5 weight parts), the amount of silica “R202” (0.5 or 0.7 weight parts), the amount of silica “RX50” (0.5 or 1.0 weight parts) and the stirring time (1 to 7 minutes) are varied so that 10 kinds of toner (referred to as toner 11 through 20) are obtained. The amount of the respective external additives and the stirring time are shown in Table 3.

For each of the toner 11 through 20, a dispersion is made as was described in the first embodiment, and the turbidity of the dispersion is measured as was described in the first embodiment. The result of the measurement is shown in Table 3.

TABLE 3

| | | amount (weight parts) | | | | | |
|---|---|---|---|---|---|---|---|
| | mother | KE- | | | | stir | |
| | particle | P10- | | | | time | |
| toner | (A/B) | S1 | R202 | RX50 | T805 | (min) | turbidity |
| 11 | A | 0.5 | 0.5 | 0.5 | 0.1 | 7 | 6.7 |
| 12 | B | 0.5 | 0.5 | 0.5 | 0.1 | 7 | 7.5 |
| 13 | A | 0.5 | 0.5 | 1.0 | 0.1 | 6 | 10.1 |
| 14 | B | 0.5 | 0.5 | 1.0 | 0.1 | 5 | 16.4 |
| 15 | A | 1.0 | 0.5 | 1.0 | 0.1 | 4 | 23.4 |
| 16 | B | 1.0 | 0.5 | 1.0 | 0.1 | 3 | 29.7 |
| 17 | A | 1.5 | 0.7 | 1.0 | 0.1 | 3 | 34.2 |
| 18 | B | 1.5 | 0.7 | 1.0 | 0.1 | 2 | 39.8 |
| 19 | A | 1.5 | 0.7 | 1.0 | 0.1 | 1 | 42.2 |
| 20 | B | 1.5 | 0.7 | 1.0 | 0.1 | 1 | 43.6 |

Further, using the toner 11 through 20, the cleaning performance in the image forming apparatus is evaluated. In the image forming apparatus, the cleaning blade 9 with the rebound elasticity varied from 30% to 85% contacts the surface of the photosensitive drum 1. The printing condition is the same as that in the first embodiment. The result of the evaluation is shown in Table. 4.

TABLE 4

| | Cleaning Performance | | | | |
|---|---|---|---|---|---|
| toner | RE 30% | RE 40% | RE 60% | RE 80% | RE 85% |
| 11 | X | X | X | X | X |
| 12 | X | X | X | X | X |
| 13 | X | ◯ | ◯ | ◯ | X |
| 14 | X | ◯ | ◯ | ◯ | X |
| 15 | X | ◯ | ◯ | ◯ | X |
| 16 | X | ◯ | ◯ | ◯ | X |
| 17 | X | ◯ | ◯ | ◯ | X |
| 18 | X | ◯ | ◯ | ◯ | X |
| 19 | X | X | X | X | X |
| 20 | X | X | X | X | X |

According to Tables. 3 and 4, the cleaning failure does not occur when the turbidity of the dispersion ranges from 10 to 40 (i.e., toner 13 to 18) and the rebound elasticity of the cleaning blade 9 ranges from 40% to 80%.

The range of the turbidity when the cleaning failure does not occur in this embodiment (10-40) is broader than in the first embodiment (20-40). It is considered that, if the large external additives (whose mean particle diameter is greater than 100 nm) exist between the cleaning blade 9 and the photosensitive body 1, the effect of preventing the passage of toner is enhanced even when the amount of the large external additives is small. Thus, it is considered that the occurrence of the cleaning failure can be prevented when the turbidity of the dispersion is greater than or equal to 10.

As was described in the first embodiment, it is understood that, if the rebound elasticity of the cleaning blade 9 is from 40% to 80%, the edge 9a of the cleaning blade 9 is not easily deformed by the toner, and abrasion or chipping of the cleaning blade 9 does not easily occur, with the result that the passage of the toner through between the edge 9a and the photosensitive body 1 can be prevented, i.e., the occurrence of the cleaning failure can be prevented.

In the above described experiment, the mean particle diameter of “SEAHOSTAR KE-P10-S1” is 110 nm. However, the same experimental result is obtained when the mean particle diameter of the large external additives is greater than or equal to 100 nm. This is because, if the mean particle diameter of the large external additives is greater than or equal to 100 nm, the effect of preventing the passage of the toner through between the cleaning blade 9 and the photosensitive drum 1 is enhanced by the accumulation of the external additives between the cleaning blade 9 and the photosensitive drum 1.

As described above, according to the second embodiment of the present invention, in the case where the external additives with a mean particle diameter greater than 100 nm are added, the turbidity of the dispersion (in which 1 weight part of the toner is dispersed in 3.5 weight parts of ethyl alcohol and 100 weight parts of water) ranges from 10 to 40, and the rebound elasticity of the cleaning blade 9 ranges from 40% to 80%, it is possible to improve the cleaning performance, and to thereby improve the image quality.

In the above described embodiments, the experimental results when cyan toner is used have been described. However, even when yellow, magenta, or black toner is used, the same experimental results are obtained.

Further, in the above described embodiments, the toner is made by emulsion polymerization. However, the toner can be made by other method as long as substantially spherical particles are obtained. For example, it is possible to employ suspension polymerization or to combine milling and heat-treating. Moreover, the cleaning blade can be made of material other than urethane elastomer, as long as the material has rubber elasticity.

The present invention can be adapted to an image forming apparatus other than an electrophotographic color printer. For example, the present invention can be adapted to a monochrome printer, a copier or a facsimile or the like.

While the preferred embodiments of the present invention have been illustrated in detail, it should be apparent that modifications and improvements may be made to the invention without departing from the spirit and scope of the invention as described in the following claims.

What is claimed is:

1. An image forming apparatus comprising:
an image bearing body;
a charging unit that electrically charges said image bearing body;
a latent image forming unit that forms a latent image on said image bearing body charged by said charging unit;
a developing unit that develops said latent image on said image bearing body by means of a developer including mother particles and external additives;
a transfer unit that transfers a developed image to a medium; and
a cleaning unit having a cleaning blade that removes said developer that remains on said image bearing body without being transferred to said medium, said cleaning blade having a rebound elasticity from 40% to 80%,
wherein a mean value of degrees of circularity of said mother particles of said developer is greater than or equal to 0.94, and
wherein, when 1 weight part of said developer is dispersed in 3.5 weight parts of ethyl-alcohol and 100 weight parts of water to obtain a dispersion, a turbidity of said dispersion ranges from 20 to 40.

2. An image forming apparatus comprising:
an image bearing body;
a charging unit that electrically charges said image bearing body;
a latent image forming unit that forms a latent image on said image bearing body charged by said charging unit;
a developing unit that develops said latent image on said image bearing body by means of a developer including mother particles and external additives;
a transfer unit that transfers a developed image to a medium; and
a cleaning unit having a cleaning blade that removes said developer that remains on said image bearing body without being transferred to said medium, said cleaning blade having a rebound elasticity from 40% to 80%,
wherein a mean value of degrees of circularity of said mother particles of said developer is greater than or equal to 0.94, and said external additives include at least one kind of external additives whose mean particle diameter is greater than or equal to 100 nm, and
wherein, when 1 weight part of said developer is dispersed in 3.5 weight parts of ethyl-alcohol and 100 weight parts of water to obtain a dispersion, a turbidity of said dispersion ranges from 10 to 40.

3. A developer comprising mother particles and external additives,
wherein a mean value of degrees of circularity of said mother particles is greater than or equal to 0.94, and
wherein, when 1 weight part of said developer is dispersed in 3.5 weight parts of ethyl-alcohol and 100 weight parts of water to obtain a dispersion, a turbidity of said dispersion ranges from 20 to 40.

4. A developer comprising mother particles and external additives,
wherein a mean value of degrees of circularity of said mother particles is greater than or equal to 0.94, and said external additives include at least one kind of external additives whose mean particle diameter is greater than or equal to 100 nm, and
wherein, when 1 weight part of said developer is dispersed in 3.5 weight parts of ethyl-alcohol and 100 weight parts of water to obtain a dispersion, a turbidity of said dispersion ranges from 10 to 40.
